(19) United States
(12) Patent Application Publication
(10) Pub. No.: US 2021/0165388 A1
(43) Pub. Date: Jun. 3, 2021

(54) GIMBAL ROTATION CONTROL METHOD AND APPARATUS, CONTROL DEVICE, AND MOVABLE PLATFORM

(71) Applicant: SZ DJI TECHNOLOGY CO., LTD., Shenzhen (CN)

(72) Inventors: Yingzhi WANG, Shenzhen (CN); Shuai LIU, Shenzhen (CN); Zhendong WANG, Shenzhen (CN)

(21) Appl. No.: 17/174,512

(22) Filed: Feb. 12, 2021

Related U.S. Application Data
(63) Continuation of application No. PCT/CN2018/103596, filed on Aug. 31, 2018.

(51) Int. Cl. G05B 19/19; F16M 11/18; G05D 3/20; F16M 11/12; G05D 1/00

(52) U.S. Cl. CPC G05B 19/19; F16M 11/18; G05D 1/0094; F16M 11/123; G05D 3/20

(57) ABSTRACT

A method for controlling a gimbal to rotate is provided. The method includes obtaining an attitude angle of the gimbal and an attitude angle of a base coupled to the gimbal in response to a trigger signal, and controlling the gimbal to rotate based on the attitude angle of the base and the attitude angle of the gimbal, such that the gimbal follows the base to rotate.

### CROSS-REFERENCE TO RELATED APPLICATION

This application is a continuation of International Application No. PCT/CN2018/103596, filed on Aug. 31, 2018, the entire content of which is incorporated herein by reference.

### TECHNICAL FIELD

The present disclosure relates to the technical field of electronics technology and, more particularly, to a gimbal rotation control method and apparatus, a control device, and a movable platform.

### BACKGROUND

A gimbal is a supporting device. The gimbal is characterized by carrying an external device on one hand and being fixed to another device or position on the other hand. A typical application scenario of the gimbal is photographing by an unmanned aerial vehicle (UAV), in which one end of the gimbal is fixed to a suitable position at a housing of the UAV and another end of the gimbal carries a camera. The camera can be controlled to photograph at various directions by controlling the rotation of the gimbal. In addition to carrying the camera, the gimbal may also carry another device, such as a searchlight, such that the UAV can shine light in various directions.

Various functions may be performed by the gimbal. A more obvious one is controlling the rotation of the gimbal to photograph required images in multiple directions. Additional functions may be performed by the gimbal mounted at a device such as a UAV, a robot, a self-driving car to follow photographed objects. That is, controlling the rotation of the gimbal to rotate the camera with the rotation of the device such as the UAV, such that the camera always faces toward a fixed direction (such as a direction of movement of the UAV) for photographing images directly ahead.

How to control the rotation of the gimbal under various circumstances to ensure a desired performance of a following function becomes a research focus.

### SUMMARY

In accordance with the disclosure, there is provided a method for controlling a gimbal to rotate. The method includes obtaining an attitude angle of the gimbal and an attitude angle of a base coupled to the gimbal in response to a trigger signal, and controlling the gimbal to rotate based on the attitude angle of the base and the attitude angle of the gimbal, such that the gimbal follows the base to rotate.

In accordance with the disclosure, there is provided a control device. The control device includes a communication interface configured to be connected to a gimbal connected to a base, and a controller configured to obtain an attitude angle of the gimbal and an attitude angle of the base in response to a trigger signal, and to control the gimbal to rotate based on the attitude angle of the base and the attitude angle of the gimbal, such that the gimbal follows the base to rotate.

In accordance with the disclosure, there is provided a movable platform. The movable platform includes: a body; a propulsion assembly configured to provide propulsion for the movable platform; a gimbal coupled to the body via a base; and a controller configured to control the propulsion assembly and to obtain an attitude angle of the gimbal and an attitude angle of the base in response to a trigger signal, and to control the gimbal to rotate based on the attitude angle of the base and the attitude angle of the gimbal, such that the gimbal follows the base to rotate.

### BRIEF DESCRIPTION OF THE DRAWINGS

To more clearly illustrate the technical solution of the present disclosure, the accompanying drawings used in the description of the disclosed embodiments are briefly described below. The drawings described below are merely some embodiments of the present disclosure. Other drawings may be derived from such drawings by a person with ordinary skill in the art without creative efforts and may be encompassed in the present disclosure.

FIG. 1 is a flowchart of a method for controlling rotation of a gimbal according to an example embodiment of the present disclosure.

FIG. 2 is a schematic structural diagram of a gimbal architecture according to an example embodiment of the present disclosure.

FIG. 3 is a schematic structural diagram of a gimbal architecture according to another example embodiment of the present disclosure.

FIG. 4 is a schematic structural diagram of a gimbal architecture according to another example embodiment of the present disclosure.

FIG. 5 is a flowchart of a method for controlling rotation of a gimbal according to another example embodiment of the present disclosure.

FIG. 6 is a schematic structural diagram of a gimbal rotation control apparatus according to an example embodiment of the present disclosure.

FIG. 7 is a schematic structural diagram of a control device according to an example embodiment of the present disclosure.

FIG. 8 is a schematic structural diagram of a movable platform according to an example embodiment of the present disclosure.

### DETAILED DESCRIPTION OF THE EMBODIMENTS

Embodiments of the present disclosure are described in detail below with reference to the accompanying drawings. It will be appreciated that the described embodiments are some rather than all of the embodiments of the present disclosure. Other embodiments obtained by those having ordinary skills in the art on the basis of the described embodiments without inventive efforts should fall within the scope of the present disclosure.

As such, a feature indicated in this specification is used to describe one of the features of the embodiments of the present disclosure, rather than implying that the embodiments of the present disclosure must have the described feature. In addition, this specification describes many features. Although certain features are combined to illustrate possible system designs, these features can also be combined in manners that are not explicitly indicated. Thus, unless otherwise specified, the illustrated combinations are not intended to be limiting.

In the embodiments shown in the drawings, direction indications (such as up, down, left, right, front, and back) are used to explain structures and movements of various elements of the present disclosure, which are not absolute but relative. When the elements are in positions shown in the drawings, the descriptions are appropriate. If description of the positions of the elements changes, the direction indications will also change accordingly.

Hereinafter, some embodiments of the present disclosure will be further described in detail with reference to the accompanying drawings in the specification. In case of no conflict, the embodiments and features described in the embodiments can be combined with each other.

A movable platform such as a UAV or a self-driving car may carry a load device of various types according to actual needs. The load device may be directly fixed to the movable platform or may be mounted at the movable platform through a gimbal. The gimbal may include a frame structure composed of one or more frame members. The load device is mounted at a certain frame member of the frame structure. The gimbal is connected to the movable platform through a base. The base can be fixed to the movable platform. The gimbal is a device controllable for its rotation direction. After the load device is mounted at the gimbal, a photographing direction of the load device can be controlled by controlling rotation of the gimbal. Thus, the load device can photograph surrounding images in various directions according to a user's need.

In some embodiments, the load device includes a photographing device. Because the photographing device is capable of photographing the surrounding images, through mounting the photographing device at the movable platform, on one hand, the images can be photographed to produce various videos to satisfy the user's need, on the other hand, the photographed images can be provided as data for assisting the movement of the movable platform such as the UAV and a smart robot, thereby facilitating the movable platform such as the UAV and the smart robot to perform functions such as obstacle avoidance and positioning based on real-time surrounding images. The load device may also include another device such as a lighting device and a loudspeaker. For illustration purpose, a commonly seen photographing device is described as the load device.

In some embodiments, the movable platform such as the UAV and the smart robot is provided with various sensors and controllers. For example, the various sensors include an inertial measurement unit (IMU) for detecting movement attitude of the movable platform and a compass for detecting a movement direction of the movable platform. The movable platform may be a device or structure equipped with sensors such as the IMU and the compass, for example, an unmanned automobile provided with the load device through the gimbal, and a handheld gimbal provided with the load device through the gimbal.

When the movable platform such as the UAV and the unmanned automobile is moving and the photographing device needs to perform following shot, a photographing direction of the photographing device may be controlled by controlling the rotation of the gimbal. In some embodiments, the movable platform is the UAV. When the photographing device needs to perform following shot, the UAV hovers and rotates on a YAW-axis (turning a direction of a UAV nose), the gimbal is controlled to rotate, such that the photographing device also rotates on the YAW-axis to follow the UAV nose and photograph images directly in front of the UAV nose. In some other embodiments, when the UAV nose rotates on a PITCH-axis (i.e., the UAV nose swings up and down), the gimbal is controlled to rotate, such that the photographing device also rotates on the PITCH-axis to follow the UAV nose and photograph images directly in front of the UAV nose.

In some embodiments, when the gimbal is controlled to rotate the photographing device to perform following shot, an attitude angle of the movable platform is determined based on data obtained by the sensors of the movable platform. The determined attitude angle includes an attitude angle on the YAW-axis, an attitude angle on the PITCH-axis, and an attitude angle on a ROLL-axis of the movable platform. Thus, perform following shot can be achieved by controlling the gimbal to rotate based on these attitude angles.

Considering that errors or interferences may exist when the attitude of the movable platform is obtained, the gimbal may be rotated to follow an incorrect attitude angle. For example, in a substantial electromagnetic interference environment, the compass of the movable platform may be substantially interfered to provide incorrect direction data, thereby causing the movable platform to rotate about a yaw axis based on incorrect data. As such, in some embodiments, because the gimbal is connected to the movable platform through a base, an attitude of the base may substitute the attitude of the movable platform. Both an attitude angle of the gimbal and an attitude angle of the base are used to control the rotation of the gimbal to achieve an objective of following shot by the load device without a need for the attitude data of the movable platform, in particular, the attitude data subject to substantial interference, such as compass data interfered by strong magnetic fields.

FIG. 1 is a flowchart of a method for controlling rotation of a gimbal according to an example embodiment of the present disclosure. The method may be performed by a specialized control device or by a control device provided at the movable platform for data processing. The control device communicates with the gimbal and the movable platform and controls the rotation of the gimbal based on information such as obtained sensor data.

In some embodiments, the gimbal includes the frame structure provided for carrying the photographing device. The gimbal is connected to the movable platform through the base. As shown in FIG. 1, at S101, after receiving a trigger signal, the control device enters a pseudo-follow mode. In the pseudo-follow mode, both the attitude angle of the gimbal and the attitude angle of the base are obtained. The trigger signal may be generated when the sensors such as the IMU and the compass of the movable platform are interfered and unable to operate normally. The trigger signal may be generated and transmitted by the sensors of the movable platform or by the control device. The trigger signal may also be transmitted in response to an external command inputted by a user after the user discovers that the photographing device cannot perform following shot properly. The pseudo-follow mode is entered in response to the triggering signal. In the pseudo-follow mode, the attitude of the base is replaced by the attitude of the movable platform. The control device obtains the attitude angle of the gimbal and the attitude angle of the base at S101.

The gimbal is provided with a first IMU. The attitude angle of the gimbal is obtained by the first IMU. In some embodiments, a motor assembly of the gimbal is provided with a joint angle acquisition assembly for obtaining a joint angle of the motor assembly. As such, the attitude angle of the base may be obtained based on the attitude angle of the gimbal and the joint angle of the motor assembly. In some other embodiments, the base is provided with a second IMU, and the attitude angle of the base is obtained by the second IMU.

In other words, the attitude angle of the base may be calculated in two methods. In one method, the attitude angle of the base is calculated based on the attitude angle of the gimbal and the joint angle of the motor assembly. In another method, the attitude angle is obtained directly by the IMU. In some embodiments, the two methods may be combined. Data obtained by the IMU of the base is used to determine a first sub attitude angle, and the attitude angle of the gimbal and the joint angle of the motor assembly are used to determine a second sub attitude angle. A final attitude angle of the base is calculated based on the first sub attitude angle and the second sub attitude angle. In one example, yaw angles, roll angles, and pitch angles of the first sub attitude angle and the second sub attitude angle may be averaged to obtain a yaw angle, a roll angle, and a pitch angle of the base, respectively. In another example, the second sub attitude angle is used to correct the first sub attitude angle to obtain the more accurate attitude angle of the base.

After the attitude angle of the gimbal and the attitude angle of the base are obtained, at S102, the gimbal is controlled to follow the base to rotate based on the attitude angle of the gimbal and the attitude angle of the base. The attitude angle of the gimbal and the attitude angle of the base are used to determine follow information, and the gimbal is controlled to rotate based on the follow information. In some embodiments, the follow information may be angle information. The angle information may refer to a difference between the attitude angle of the gimbal and the attitude angle of the base. The gimbal is controlled to rotate based on the difference in a target rotation direction by an angle indicated by the difference. In some other embodiments, the follow information may be angular velocity information or angular acceleration information. In this case, the gimbal is controlled to rotate according to the angular velocity information or the angular acceleration information.

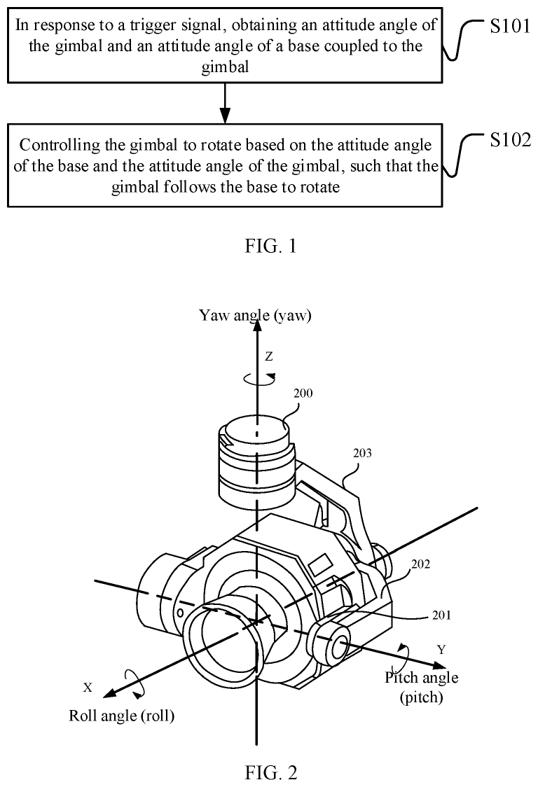

In some embodiments, the frame structure of the gimbal includes three frame members. FIG. 2 is a schematic structural diagram of a gimbal architecture according to an example embodiment of the present disclosure. As shown in FIG. 2, the frame structure includes a yaw-axis frame, a roll-axis frame, and a pitch-axis frame. One end of the yaw-axis frame is rotationally connected to the base. Another end of the yaw-axis frame is rotationally connected to one end of the roll-axis frame. Another end of the roll-axis frame is rotationally connected to the pitch-axis frame. The photographing device is fixedly provided at the pitch-axis frame.

The attitude angle of the gimbal can be obtained by calculating sensing data of the IMU disposed at the pitch-axis frame. The attitude angle of the gimbal includes: a yaw angle, a pitch angle, and a roll angle. Whether a trigger signal transmitted by the movable platform and indicating that a current environment is a strong electromagnetic interference environment is received is detected in real time or periodically. After it is detected that the trigger signal is received, execution of S101 is started.

Before, after, or at the same time as obtaining the attitude angle of the gimbal, the control device obtains joint angle data of the frame structure of the gimbal to obtain a joint angle of the frame structure. The joint angle of the frame structure includes a joint angle of the pitch-axis frame, a joint angle of the roll-axis frame, and a joint angle of the yaw-axis frame. The control device calculates the obtained joint angle of the frame structure and the attitude angle of the gimbal to obtain the attitude angle of the base. In other words, the attitude angle of the base is obtained by calculating the attitude angle of the gimbal and the joint angle of the frame structure. It should be noted that the attitude angle refers to a rotation angle of a component in a three-dimensional space, for example, the rotation angle of the frame structure in the three-dimensional space. The joint angle refers to an angle between two rotationally connected mechanisms. The joint angle may be a rotation angle between two frame members of the frame structure or may be a rotation angle between the yaw-axis frame and the base.

In some embodiments, the gimbal also includes a motor assembly. The motor assembly rotates to drive the yaw-axis frame, the roll-axis frame, and the pitch-axis frame to rotate. The joint angle of the frame structure may be sensed by a sensor (for example, a Hall sensor, a potentiometer, a magnetic encoder, or another suitable sensor) disposed at each motor.

In some embodiments, the calculating the obtained joint angle of the frame structure and the attitude angle of the gimbal to obtain the attitude angle of the base includes: determining the attitude angles of the three frame members based on the attitude angle of the gimbal; and calculating the attitude angles and the joint angles of the three frame members to obtain the attitude angle of the base.

FIG. 2 is a schematic structural diagram of a gimbal architecture according to an example embodiment of the present disclosure. As shown in FIG. 2, the three frame members include a pitch-axis frame 201, a roll-axis frame 202, and a yaw-axis frame 203. A sensor such as a Hall sensor is disposed at the motor assembly between the pitch-axis frame 201 and the roll-axis frame 202, the motor assembly between the roll-axis frame 202 and the yaw-axis frame 203, and the motor assembly between the yaw-axis frame 203 and a base 200, respectively to sense the corresponding joint angle. For example, the Hall sensor disposed at the motor of the yaw-axis frame 203 is configured to sense the joint angle of the yaw-axis frame 203 rotating relative to the base 200. The Hall sensor disposed at the motor of the roll-axis frame 202 is configured to sense the joint angle of the roll-axis frame 202 rotating relative to the yaw-axis frame 203. The Hall sensor disposed at the motor of the pitch-axis frame 201 is configured to sense the joint angle of the pitch-axis frame 201 rotating relative to the roll-axis frame 202.

The attitude angle of the pitch-axis frame 201 is the attitude angle of the gimbal. The joint angle of the base 200 is calculated based on the frame structure shown in FIG. 2 as follows. The known attitude angle of the pitch-axis frame 201 is obtained at first. The attitude angle of the roll-axis frame 202 is calculated based on the attitude angle of the pitch-axis frame 201 and the joint angle of the roll-axis frame 202 on a Y-axis (a PITCH-axis). The joint angle used in the calculation is the joint angle around the PITCH-axis. The joint angle around the PITCH-axis is used to compensate a pitch angle component in the attitude angle.

The attitude angle of the yaw-axis frame 203 is calculated based on the attitude angle of the roll-axis frame 202 and the joint angle of the yaw-axis frame 203 on an X-axis (a ROLL-axis). The joint angle used in the calculation is the joint angle around the ROLL-axis. The joint angle around the ROLL-axis is used to compensate a roll angle component in the attitude angle.

The attitude angle of the base 200 is calculated based on the attitude angle of the yaw-axis frame 203 and the joint angle of the base 200 along the base 200 on a Z-axis (a YAW-axis). The joint angle used in the calculation is the joint angle around the YAW-axis. The joint angle around the YAW-axis is used to compensate a yaw angle component in the attitude angle.

In some embodiments, the IMU disposed at the pitch-axis frame 201 is configured to detect the attitude angle of the gimbal on the YAW-axis, the PITCH-axis, and the ROLL-axis, that is, the yaw angle, the pitch angle, and the roll angle. The attitude angle of the gimbal may be obtained by performing an integration on sensing data of the IMU, such as gyroscope data.

In some embodiments, FIG. 2 is taken as an example to describe the specific derivation process of determining the attitude angle of the base 200 based on the attitude angle and the joint angle of the gimbal, to further explain how to calculate the attitude angle of the base 200 based on the attitude angles and the joint angles of the three frame members.

The measured attitude angle and the joint angle of the gimbal are known. Starting from the attitude angle of the base 200 (unknown and to-be-calculated), the base 200 rotates around the Z-axis of the base 200 by the joint angle joint_angle[frame_out] of the yaw-axis frame 203 to obtain the attitude angle of the yaw-axis frame 203. The yaw-axis frame 203 rotates around the X-axis of the yaw-axis frame 203 by the joint angle joint_angle[frame_mid] of the roll-axis frame 202 to obtain the attitude angle of the roll-axis frame 202. The roll-axis frame 202 rotates around the Y-axis of the roll-axis frame 202 by the joint angle joint_angle[frame_inn] of the pitch-axis frame 201 to obtain the attitude angle of the pitch-axis frame 201. The attitude angle of the pitch-axis frame 201 is the attitude angle of the gimbal.

An axis angle is converted to a quaternion to obtain q(joint_angle[frame_out], AXIS_Z), q(joint_angle[frame_mid], AXIS_X), and q(joint_angle[frame_inn], AXIS_Y). For the convenience of description, the following expression can be performed:

let q(joint_angle[frame_out], AXIS_Z) be q_out;

let q(joint_angle[frame_mid], AXIS_X) be q_mid; and

let q(joint_angle[frame_inn], AXIS_Y) be q_inn.

Further, q_camera_meas (the quaternion representation of the measured attitude angle of the gimbal)=q_base (the attitude angle of the base 200)*q_out*q_mid*q_inn. Thus, the attitude angle of the base 200 can be obtained from measured attitude angle and measured joint angle of the gimbal according to the following equation:

q__{base}=q_camera_mea*q_inn⁻¹*q_out⁻¹.

The above-described process of calculating the attitude angle of the base 200 is the expression for calculating q_base. In other words, the joint angle of the yaw-axis frame 203, the roll-axis frame 202, and the pitch-axis frame 201 are used to compensate the attitude angle of the gimbal to obtain the attitude angle of the base 200. Thus, the attitude angle of the gimbal and the attitude angle of the base 200 are used to control the subsequent rotation of the gimbal.

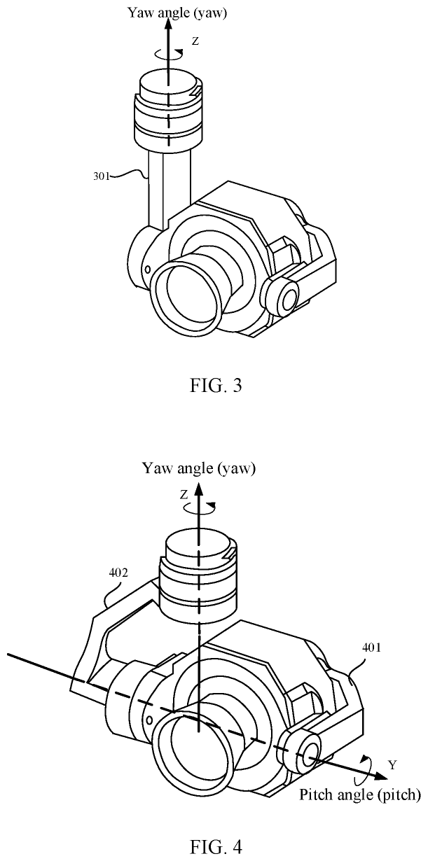

In addition, for a two-axis gimbal or a single-axis gimbal, the similar derivation can be performed to calculate the attitude of the base. FIG. 3 is a schematic structural diagram of a gimbal architecture according to another example embodiment of the present disclosure. As shown in FIG. 3, the gimbal only rotates in the yaw angle. The attitude of the gimbal and the joint angle of the frame member 301 are used to compensate the yaw angle of the gimbal to obtain the attitude angle of the base. The yaw angle of the base is the compensated attitude angle. The pitch angle and the roll angle of the base are the same as the pitch angle and the roll angle of the gimbal, respectively. FIG. 4 is a schematic structural diagram of a gimbal architecture according to another example embodiment of the present disclosure. As shown in FIG. 4, the gimbal rotates by the yaw angle and the pitch-angle. The attitude angle of the gimbal and the joint angle of the frame member 401 are used to compensate the pitch angle of the gimbal. The join tangle of the frame member 402 is used to further compensate the yaw angle of the gimbal to obtain the attitude angle of the base. The pitch angle and the yaw angle of the base are the angles compensated by the pitch angle and the yaw angle of the gimbal while the roll angle of the base is the same as the roll angel of the gimbal.

FIGS. 2-4 are merely some examples. The frame members of the gimbal may rotate around different axes. For example, for another example gimbal, the photographing device is mounted at the roll-axis frame rather than at the pitch-axis frame as shown in FIG. 2. As such, the motor assembly disposed between the roll-axis frame and the pitch-axis frame is sensed to obtain a first joint angle. The first joint angle is used to compensate the roll angle component of the attitude angle of the roll-axis frame. Further, the motor assembly disposed between the pitch-axis frame and the yaw-axis frame is sensed to obtain a second joint angle. The second joint angle is used to compensate the pitch angle component of the attitude angle of the roll-axis frame. Further, motor assembly disposed between the yaw-axis frame and the base is sensed to obtain a third joint angle. The third joint angle is used to compensate the yaw angle component of the attitude angle of the roll-axis frame. The compensated roll angle, pitch angle, and yaw angle form the attitude angle of the base.

After the attitude angle of the base is calculated, the control device calculates the follow information based on the attitude angle of the base and the attitude angle of the gimbal, and controls the gimbal to rotate based on the follow information, thereby facilitating the rotation of the gimbal to follow the base.

In some embodiments, the follow information may be an angle difference. When the gimbal is being controlled to rotate, the gimbal is controlled to directly rotate by an angle corresponding to the angle difference from the current attitude angle of the gimbal. Based on a magnitude of the attitude angle of the base and the magnitude of the attitude angle of the gimbal, a rotation direction is determined. For example, the gimbal may be controlled to rotate in the yaw angle direction based on the yaw angle difference, and/or in the pitch angle direction based on the pitch angle difference, and/or in the roll angle direction based on the roll angle difference.

In some embodiments, when controlling the gimbal to rotate based on the attitude angle of the base and the attitude angle of the gimbal, the control device controls the gimbal to rotate in the yaw direction based on the attitude angle of the base, such that the yaw angle of the rotated gimbal and the yaw angle component of the attitude angle of the base satisfies a first similarity condition; and/or the control device controls the gimbal to rotate in the pitch direction based on the attitude angle of the base, such that the pitch angle of the rotated gimbal and the pitch angle component of the attitude angle of the base satisfies a second similarity condition; and/or the control device controls the gimbal to rotate in the roll direction based on the attitude angle of the base, such that the roll angle of the rotated gimbal and the roll angle component of the attitude angle of the base satisfies a third similarity condition. The similarity conditions may refer to the same or having an error is within a substantially small error threshold range. For example, the angle of the gimbal after the gimbal is controlled to rotate in the yaw direction and the yaw angle component of the attitude angle of the base are the same or have an error within a pre-configured error range to satisfy the first similarity condition. The angle of the gimbal after the gimbal is controlled to rotate in the pitch direction and the pitch angle component of the attitude angle of the base are the same or have an error within the pre-configured error range to satisfy the second similarity condition. The angle of the gimbal after the gimbal is controlled to rotate in the roll direction and the roll angle component of the attitude angle of the base are the same or have an error within the pre-configured error range to satisfy the third similarity condition.

In some embodiments, the follow information may be a velocity-related value, such as an angular velocity value or an angular acceleration value. Based on the velocity-related value, the gimbal is controlled to rotate at the corresponding angular velocity or angular acceleration without specifying any rotation angle. Specifically, comparison between multiple rotation control methods (for example, controlling based on an angle value, controlling based on an angle difference, controlling based on a velocity, etc.) shows that controlling the rotation of the gimbal based on a following velocity-related value without forcing the gimbal to rotate for a specified angle value can avoid substantial swings of the gimbal during the following control caused by interference on the movable platform such as the UAV. The substantial swings of the gimbal may be caused by frequent rotation of a UAV nose when the UAV is subject to interference. When the gimbal is controlled to rotate according to the angle value or the angle difference to achieve a following objective, the gimbal is forced to rotate to the corresponding angle. In this case, it is possible that before the gimbal is rotated to follow the angle of the UAV nose, the UAV nose rotates again by a certain angle, thereby causing the substantial swing of the gimbal. When the gimbal is controlled to rotate to follow based on the velocity-related value, the gimbal only needs to be rotated at the angle velocity or the angular acceleration, and is not forced to rotate to the specified angle, thereby avoiding the substantial swings of the gimbal.

In some embodiments, to simplify the calculation of the follow information, and particularly the angular velocity or the angular acceleration, the attitude of the base is converted by a conversion equation to a corresponding Euler angle, and the attitude angle of the gimbal is converted by another conversion equation to another corresponding Euler angle. The Euler angle corresponding to the base is expressed as: (euler_base_pitch, euler_base_roll, euler_base_yaw), and the Euler angle corresponding to the gimbal is expressed as: (euler_camera_pitch, euler_camera_roll, euler_camera_yaw). The follow information may be obtained by calculating the converted Euler angles.

In some embodiments, after the follow information is calculated, the gimbal is controlled to rotate about the yaw axis based on the follow information (e.g., the angular velocity or the angular acceleration of the yaw angle). In some other embodiments, the gimbal is controlled to rotate about the pitch axis based on the follow information (e.g., the angular velocity or the angular acceleration of the pitch angle). In some other embodiments, the gimbal is controlled to rotate about the roll axis based on the follow information (e.g., the angular velocity or the angular acceleration of the roll angle).

In some embodiments, calculating the follow information based on the attitude angle of the base and the attitude angle of the gimbal includes: calculating angle change values of the attitude angle of the base and the attitude angle of the gimbal; and obtaining the follow information based on the calculated angle change values. The angle change values are difference values of the attitude angle of the base and the attitude angle of the gimbal, such as one or more of a yaw angle difference value, a pitch angle difference value, and a roll angle difference value. The angle change value and a pre-configured following time value are used to calculate the angular velocity or the angular acceleration. The pre-configured time value can be an empirical value or can be configured by a user. When it is desired to control the gimbal to follow the UAV nose quickly, a smaller following time value can be configured.

After calculating the angle change value to obtain the follow information, the control device can perform a correction process to obtain corrected follow information. In some embodiments, a calculation is performed on the angle change value and a rotation velocity threshold based on an error quadratic curve calculation rule using a pre-configured proportional coefficient. Taking the yaw angle as an example, a follow target of the gimbal is changed from a flight attitude fight_atti_yaw to the base attitude euler_base_yaw. A difference between the attitude of the base and the attitude of the gimbal is used to calculate a following angular velocity. When calculating the following velocity, the error quadratic curve is used to calculate the angular velocity to reduce influence of the vibration of the UAV on the velocity of the gimbal.

The angle change value is calculated by the equation err=eulaer_base_yaw−camera_yaw, and the follow information is calculated by the equation including the error quadratic curve

$$spd = {( K * \frac{err}{spd \_max} )}^{2} * {spd}_{-} max .$$

In the above equations, K is the proportional coefficient. K is used to adjust a following speed and can be adjusted as needed. The greater K, the faster the following speed. spd_max is the rotation velocity threshold. spd_max is the maximum angular velocity that can be outputted by the gimbal, and may be determined according to gimbal model or actual measurement. The above equation for calculating the follow information needs to satisfy a constraining condition, that is, K*err<spd_max. Thus, in one example, K may be configured to be a small value. In another example, before the above equation is used to calculate the follow information, whether K*err<spd_max is true is determined. If K*err<spd_max is not true, K is dynamically adjusted until K*err<spd_max is true.

The above equations for calculation are described in the form of Euler angles. Based on similar principle, another suitable calculation method using, e.g., matrices or quaternions, may also be used to obtain the follow information. The examples are merely illustrative and not limiting.

Further, the rotation of the gimbal may not always be controlled according to the attitude angle of the gimbal and attitude angle of the base. In addition to detecting whether an interference signal transmitted by the movable platform is received, before entering a pseudo-follow mode, the control device detects whether a trigger signal is received. In some embodiments, the trigger signal is transmitted by the movable platform to indicate that a current environment has substantial electromagnetic interference. If the trigger signal is received, S101 is executed, such that the attitude of the gimbal and the attitude of the base are used to control the gimbal to rotate to follow. If no trigger signal is received, it indicates that the current environment has no substantial electromagnetic interference. The control device obtains the attitude data transmitted by the movable platform, and controls the gimbal to rotate based on the attitude data transmitted by the movable platform, such that the gimbal follows the movable platform to rotate.

When no trigger signal is received, the control device directly receives the attitude data of the movable platform, performs a following process based on the attitude data of the movable platform to achieve the objective of following the movable platform by the photographing device. In this scenario, the attitude data of the movable platform may be the precise attitude data obtained by fusion data from various sensors such as the IMU, the GPS, a vision sensor, and/or a compass.

In the substantial electromagnetic interference environment, the compass at the movable platform may be interfered, making detection of a movement direction of the movable platform inaccurate. Thus, the trigger signal is generated to trigger the execution of S101 and S102. Because the substantial electromagnetic interference has no effect on the IMU, the attitude angle of the gimbal obtained by the sensor such as the IMU of the gimbal and the attitude angle of the base (directly detected or calculated based on the attitude angle and the joint angle of the gimbal) are to achieve the objective of rotating to follow.

In some embodiments, the control device may also self detect whether the movable platform is in the substantial electromagnetic interference environment. Only when the detection result is positive, S101 and S102 are executed, such that the objective of rotating with the rotation of the base to follow the movable platform to rotate. When the current environment does not have substantial electromagnetic interference, the attitude data transmitted by the movable platform is directly obtained. Based on the attitude data transmitted by the movable platform, the control device controls the gimbal to rotate, such that the gimbal follows the rotation of the movable platform.

Whether the current environment has substantial electromagnetic interference may be detected by a suitable electromagnetic interference instrument. In some embodiments, the output data of the compass disposed at the movable platform may be detected to determine change information of the output data of the compass. If the change information satisfies a change condition, it is determined that the current environment has substantial electromagnetic interference. The change information includes at least one of change frequency or change amplitude of the output data. A presence of at least one of a substantially high change frequency (higher than a frequency threshold) or a substantially large amplitude (larger than an amplitude threshold) indicates that the movable platform is in the substantial electromagnetic environment.

When it is detected that the movable platform does not have substantial electromagnetic interference, the attitude angle of the platform is sent to the gimbal. The gimbal controls the frame structure of the gimbal to rotate directly based on the attitude angle of the movable platform, such that the gimbal follows the rotation of the movable platform.

In some embodiments, when the gimbal follows the movable platform to rotate, the movable platform may not need to provide the attitude data. When the sensors disposed at the movable platform are interfered by the environment, especially the compass of the movable platform is interfered by the substantial electromagnetic interference, desired gimbal control is ensured in various environment, and the load equipment such as the photographing device can follow the movable platform to rotate.

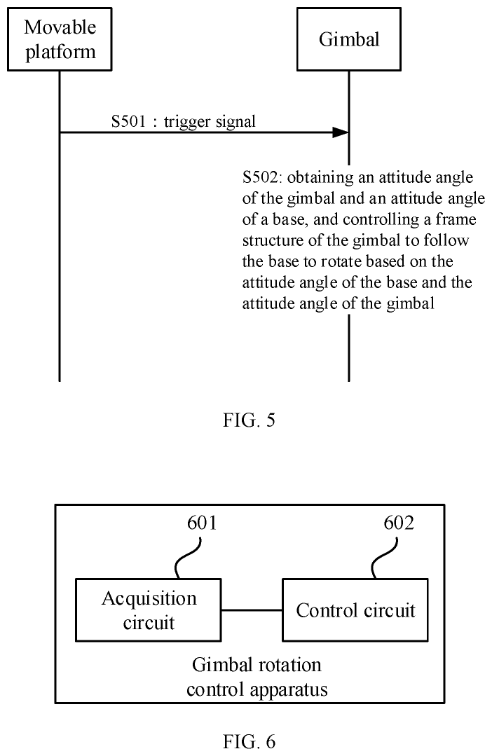

FIG. 5 is a flowchart of a method for controlling rotation of a gimbal according to another example embodiment of the present disclosure. The method may be performed through communication between the movable platform and the gimbal. The architecture of the gimbal, for example, as shown in FIG. 2, has been described in the previous embodiments. The method consistent with the embodiments of the present disclosure includes the following process.

At S501, a trigger signal is generated by a movable platform, and the trigger signal is sent to a gimbal.

At S502, after receiving the trigger signal, the gimbal enters a pseudo-follow mode. In the pseudo-follow mode, an attitude angle of the gimbal is obtained, and an attitude angle of a base is obtained. Based on the attitude angle of the base and the attitude angle of the gimbal, a frame structure of the gimbal is controlled to rotate to follow rotation of the base.

In some embodiments, the movable platform detects whether the current environment has substantial electromagnetic interference. When it is detected that the current environment has substantial electromagnetic interference, S501 is triggered to be executed. Otherwise, no trigger signal is generated, and the attitude angle of the movable platform is sent to the gimbal. Based on the attitude angle of the movable platform, the gimbal controls the frame structure of the gimbal to follow the movable platform to rotate.

In some embodiments, detecting whether the current environment has substantial electromagnetic interference includes: detecting output data of a compass by the movable platform to determine change information of the output data of the compass. If the change information satisfies a pre-configured condition, the movable platform determines that the current environment has substantial electromagnetic interference. Whether the current environment has substantial electromagnetic interference may be detected by a suitable electromagnetic interference instrument. In some embodiments, the output data of the compass disposed at the movable platform is detected to determine the change information of the output data of the compass. If the change information satisfies a change condition, it is determined that the current environment has substantial electromagnetic interference. The change information includes at least one of a change frequency or a change amplitude of the output data. A presence of at least one of a high change frequency (higher than the frequency threshold) or a large change amplitude (larger than the amplitude threshold) indicates that the movable platform has substantial electromagnetic interference.

FIG. 6 is a schematic structural diagram of a gimbal rotation control apparatus according to an example embodiment of the present disclosure. The apparatus may be applied to a standalone control device for controlling a gimbal to rotate, or may be applied to a movable platform such as a UAV, a smart robot, and a self-driving car. The gimbal includes a frame structure. The frame structure is provided for carrying load equipment. The gimbal is connected to the movable platform through a base. The gimbal may have the structure shown in FIG. 2, FIG. 3, or FIG. 4. The apparatus includes an acquisition circuit 601 and a control circuit 602.

The acquisition circuit 601 is configured to enter a pseudo-follow mode after receiving a trigger signal. In the pseudo-follow mode, an attitude angle of the gimbal and an attitude angle of the base are obtained. The control circuit 602 is configured to control the gimbal to rotate based on the attitude angle of the base and the attitude angle of the gimbal, such that the gimbal rotates to follow rotation of the base.

In some embodiments, the control circuit 602 is configured to obtain follow information based on the attitude angle of the base and the attitude angle of the gimbal, and to control the gimbal to rotate based on the follow information, such that the gimbal follows the base rotate.

In some embodiments, the control circuit 602 is configured to calculate angle change values of the attitude angle of the base and the attitude angle of the gimbal, and to obtain the follow information based on the calculated angle change values.

In some embodiments, the control circuit 602 is configured to perform a correction process on the follow information to obtain corrected follow information.

In some embodiments, the control circuit 602 is configured to perform a calculation on the angle change value and a rotation velocity threshold based on an error quadratic curve calculation rule using a pre-configured proportional coefficient to obtain the corrected follow information.

In some embodiments, the rotation velocity threshold is the maximum rotation velocity of the gimbal.

In some embodiments, the follow information includes at least one of angle information, angular velocity information, or angular acceleration information.

In some embodiments, the gimbal further includes a motor assembly. The control circuit 602 is configured to obtain joint angle data of the motor assembly to calculate joint angles of the motor assembly, and to obtain the attitude angle of the base based on the calculated joint angles of the motor assembly and the attitude angle of the gimbal.

In some embodiments, the control circuit 602 is configured to obtain the attitude angle of the base from a sensor provided at the base.

In some embodiments, the frame structure includes at least one of a yaw-axis frame, a roll-axis frame, or a pitch-axis frame. The control circuit 602 is configured to control the gimbal to rotate in a yaw direction based on the attitude angle of the base, such that a yaw angle of the rotated gimbal and a yaw angle component of the attitude angle of the base satisfy a first similarity condition, and/or to control the gimbal to rotate in a pitch direction based on the attitude angle of the base, such that a pitch angle of the rotated gimbal and a pitch angle component of the attitude angle of the base satisfy a second similarity condition, and/or to control the gimbal to rotate in a roll direction based on the attitude angle of the base, such that a roll angle of the rotated gimbal and a roll angle component of the attitude angle of the base satisfy a third similarity condition.

In some embodiments, the control circuit 602 is further configured to detect whether a trigger signal is received before entering a pseudo-follow mode.

In some embodiments, the trigger signal is transmitted by the movable platform to indicate that a current environment has substantial electromagnetic interference.

In some embodiments, the control circuit 602 is further configured to obtain attitude data transmitted by the movable platform if no trigger signal is received, and to control the gimbal to rotate based on the attitude data transmitted by the movable platform, such that the gimbal follows the movable platform to rotate.

In some embodiments, specific implementation of the acquisition circuit 601 and the control circuit 602 can be referred to the description of the foregoing embodiments, and will not be repeated herein. In addition, relationship between various functional uses of the control circuit 602 can be referred to the description of relationship between relevant method steps in the foregoing embodiments.

In some embodiments, when the gimbal is controlled to follow the movable platform to rotate, no attitude data is provided by the movable platform. When the sensors disposed at the movable platform are interfered by the environment, especially the compass at the movable platform is interfered by substantial electromagnetic interference, desired gimbal control is ensured in various environment, and load equipment such as a photographing device can follow the movable platform rotate.

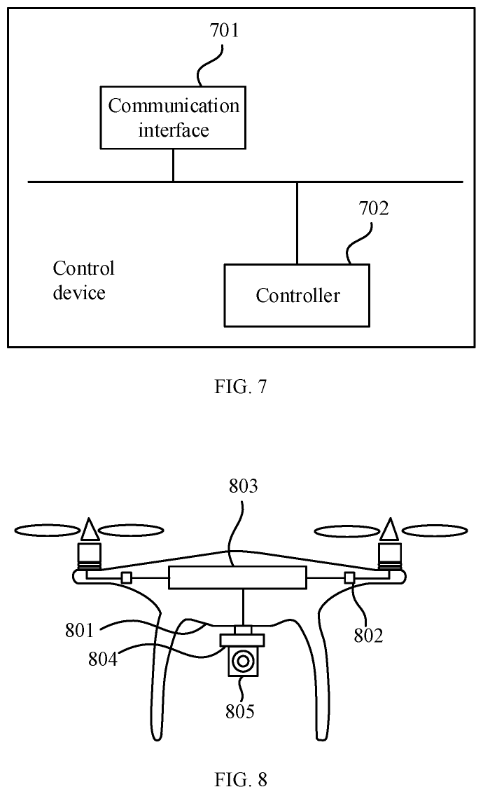

FIG. 7 is a schematic structural diagram of a control device according to an example embodiment of the present disclosure. The control device may be a standalone device for controlling a gimbal to rotate, or may be applied to a movable platform such as a UAV, a smart robot, and a self-driving car. The gimbal includes a frame structure. The frame structure is provided for carrying load equipment. The gimbal is connected to the movable platform through a base. The gimbal may have the structure shown in FIG. 2, FIG. 3, or FIG. 4.

The control device includes a communication interface 701 and a controller 702. The communication interface 701 is connected to the gimbal. The controller 702 is configured to enter a pseudo-follow mode after receiving a trigger signal, and obtain an attitude angle of the gimbal and an attitude angle of the base in the pseudo-follow mode. Based on the attitude angle of the base and the attitude angle of the gimbal, the gimbal is controlled to rotate, such that the gimbal follows the rotation of the base. Through the communication interface 701, a control command may be sent to the gimbal to control the gimbal to rotate. Specifically, a separate command is sent to a motor assembly corresponding to each frame member of the gimbal, such that the motors assembly rotates to drive the frame member of the gimbal to rotate. In addition, the communication interface 701 may also be connected to a relevant processing circuit of the movable platform to receive the trigger signal transmitted by the movable platform such as the UAV and the self-driving car through the relevant processing circuit.

The controller 702 may be a central processing unit (CPU). The controller 702 may also include a hardware chip. The hardware chip may be an application-specific integrated circuit (ASIC), or a programmable logic device (PLD). The PLD may be a field-programmable gate array (FPGA), or a generic array logic (GAL).

The control device may also include a storage device as needed. The storage device may be a volatile memory such as a random-access memory (RAM). The storage device may also be a non-volatile memory such as a flash memory, and a solid-state drive (SSD). The storage device may also be a combination of the foregoing memories. The storage device is configured to store computer program instructions for being invoked by the controller 702 to control the gimbal to rotate. The storage device is further configured to store data obtained by load equipment, such as image data obtained by a photographing device.

In some embodiments, the controller 702 is configured to calculate follow information based on the attitude angle of the base and the attitude angle of the gimbal, and to control the gimbal to rotate based on the follow information, such that the gimbal follows the base to rotate.

In some embodiments, the controller 702 is configured to calculate angle change values of the attitude angle of the base and the attitude angle of the gimbal, and to obtain the follow information based on the calculated angle change values.

In some embodiments, the controller 702 is configured to perform a correction process on the follow information to obtain corrected follow information.

In some embodiments, the controller 702 is configured to perform a calculation on the angle change value and a rotation velocity threshold based on an error quadratic curve calculation rule using a pre-configured proportional coefficient to obtain the corrected follow information.

In some embodiments, the rotation velocity threshold is the maximum rotation velocity of the gimbal.

In some embodiments, the follow information includes at least one of angle information, angular velocity information, or angular acceleration information.

In some embodiments, the gimbal further includes a motor assembly. The controller 702 is configured to obtain joint angle data of the motor assembly to calculate joint angles of the motor assembly, and to obtain the attitude angle of the base based on the calculated joint angles of the motor assembly and the attitude angle of the gimbal.

In some embodiments, the controller 702 is configured to obtain the attitude angle of the base from a sensor provided at the base.

In some embodiments, the frame structure includes at least one of a yaw-axis frame, a roll-axis frame, or a pitch-axis frame. The controller 702 is configured to control the gimbal to rotate in a yaw direction based on the attitude angle of the base, such that a yaw angle of the rotated gimbal and a yaw angle component of the attitude angle of the base satisfy a first similarity condition, and/or to control the gimbal to rotate in a pitch direction based on the attitude angle of the base, such that a pitch angle of the rotated gimbal and a pitch angle component of the attitude angle of the base satisfy a second similarity condition, and/or to control the gimbal to rotate in a roll direction based on the attitude angle of the base, such that a roll angle of the rotated gimbal and a roll angle component of the attitude angle of the base satisfy a third similarity condition.

In some embodiments, the controller 702 is further configured to detect whether a trigger signal is received before entering a pseudo-follow mode.

In some embodiments, the trigger signal is transmitted by the movable platform to indicate that a current environment has substantial electromagnetic interference.

In some embodiments, the controller 702 is further configured to obtain attitude data transmitted by the movable platform if no trigger signal is received, and to control the gimbal to rotate based on the attitude data transmitted by the movable platform, such that the gimbal follows the movable platform to rotate.

In some embodiments, specific implementation of the controller 702 can be referred to the description of the foregoing embodiments, and will not be repeated herein. In addition, relationship between various functional uses of the controller 702 can be referred to the description of relationship between relevant method steps in the foregoing embodiments.

In some embodiments, when the gimbal is controlled to follow the movable platform to rotate, no attitude data is provided by the movable platform. When the sensors disposed at the movable platform are interfered by the environment, especially the compass at the movable platform is interfered by substantial electromagnetic interference, desired gimbal control is ensured in various environment, and the load equipment such as the photographing device can follow the movable platform to rotate.

FIG. 8 is a schematic structural diagram of a movable platform according to an example embodiment of the present disclosure. The movable platform may be a smart robot, an aircraft, or a self-driving car. The aircraft is shown in FIG. 8 as an example of the movable platform for illustrating the embodiments of the present disclosure. The aircraft may be typical multi-rotor aircraft such as a quadrotor, a hexarotor, and an octorotor. The aircraft may also be a fixed-wing aircraft.

The movable platform includes a body 801, a propulsion assembly 802, a controller 803, and a gimbal 804. The body 801 mainly refers to a main structure of the movable platform, such as a fuselage structure of a UAV, and a body structure of the self-driving car. The propulsion assembly 802 mainly provides propulsion for the movable platform. For the aircraft, the propulsion assembly 802 may include structures such as electronic speed regulators, electric motors, and propellers. For the self-driving car, the propulsion assembly 802 may include structures such as an engine, and wheels. The controller 803 may be, for example, a movement control device such as a flight controller of the aircraft.

The gimbal 804 includes a frame structure. The frame structure is configured to carry load equipment 805. In some embodiments, the load equipment 805 may be a part of the movable platform, or may be a detachable external equipment. The gimbal 804 is connected to the body 801 through a base. The propulsion assembly 802 is configured to provide propulsion power for flying the movable platform. In some other embodiments, the movable platform also includes a power supply for powering the movable platform, and function structures such as a wireless communication interface for communicating with external equipment. In some other embodiments, the movable platform also includes a power module for supplying the power.

The gimbal 804 is a smart device provided with a processor. The processor may be a central processing unit (CPU). The processor may also include a hardware chip. The hardware chip may be an application-specific integrated circuit (ASIC), or a programmable logic device (PLD). The PLD may be a field-programmable gate array (FPGA), or a generic array logic (GAL).

The movable platform may also include a storage device as needed. The storage device may be a volatile memory such as a random-access memory (RAM). The storage device may also be a non-volatile memory such as a flash memory, and a solid-state drive (SSD). The storage device may also be a combination of the foregoing memories. The storage device is configured to store computer program instructions for being invoked by the controller 803 and/or the processor of the gimbal 804 to control the gimbal 804 to rotate. The storage device is further configured to store data obtained by load equipment, such as image data obtained by a photographing device.

In some embodiments, the controller 803 is configured to control the propulsion assembly 802 and to trigger the gimbal 804 to enter a pseudo-follow mode. The gimbal 804 is configured to enter the pseudo-follow mode, and to obtain an attitude angle of the gimbal 804 and an attitude angle of the base in the pseudo-follow mode. Based on the attitude angle of the base and the attitude angle of the gimbal 804, the frame structure of the gimbal 804 is controlled to follow the base to rotate.

In some embodiments, the gimbal 804 is configured to calculate follow information based on the attitude angle of the base and the attitude angle of the gimbal, and to control the gimbal 804 to rotate based on the calculated follow information, such that the gimbal 804 follows the base to rotate.

In some embodiments, the gimbal 804 is configured to calculate angle change values of the attitude angle of the base and the attitude angle of the gimbal 804, and to obtain the follow information based on the calculated the angle change values.

In some embodiments, the gimbal 804 is configured to perform a correction process on the follow information to obtain corrected follow information.

In some embodiments, the gimbal 804 is configured to perform a calculation on the angle change value and a rotation velocity threshold based on an error quadratic curve calculation rule using a pre-configured proportional coefficient to obtain the corrected follow information.

In some embodiments, the rotation velocity threshold is the maximum rotation velocity of the gimbal 804.

In some embodiments, the follow information includes at least one of angle information, angular velocity information, or angular acceleration information.

In some embodiments, the gimbal 804 further includes a motor assembly. The gimbal 804 is configured to obtain joint angle data of the motor assembly to calculate joint angles of the motor assembly, and to obtain the attitude angle of the base based on the calculated joint angles of the motor assembly and the attitude angle of the gimbal.

In some embodiments, the gimbal 804 is configured to obtain the attitude angle of the base from a sensor provided at the base.

In some embodiments, the frame structure includes at least one of a yaw-axis frame, a roll-axis frame, or a pitch-axis frame. The gimbal 804 is configured to control itself to rotate in a yaw direction based on the attitude angle of the base, such that a yaw angle of the rotated gimbal and a yaw angle component of the attitude angle of the base satisfy a first similarity condition, and/or to control itself to rotate in a pitch direction based on the attitude angle of the base, such that a pitch angle of the rotated gimbal and a pitch angle component of the attitude angle of the base satisfy a second similarity condition, and/or to control itself to rotate in a roll direction based on the attitude angle of the base, such that a roll angle of the rotated gimbal and a roll angle component of the attitude angle of the base satisfy a third similarity condition.

In some embodiments, the gimbal 804 is further configured to detect whether a trigger signal is received before entering the pseudo-follow mode.

In some embodiments, the trigger signal is transmitted by the movable platform to indicate that a current environment has substantial electromagnetic interference.

In some embodiments, the gimbal 804 is further configured to obtain attitude data transmitted by the movable platform if no trigger signal is received, and to control itself to rotate based on the attitude data transmitted by the movable platform, such that the gimbal 804 follows the movable platform to rotate.

In some embodiments, the controller 803 is configured to generate and transmit the trigger signal to the gimbal 804. The trigger signal is used to trigger the gimbal 804 to enter the pseudo-follow mode.

In some embodiments, the controller 803 is configured to detect whether the current environment has substantial electromagnetic interference.

In some embodiments, the controller 803 is configured to detect output data of a compass to determine change information of the output data of the compass. If the change information satisfies a pre-configured condition, it is determined that the current environment has substantial electromagnetic interference. The trigger signal is sent by the controller 803 to the gimbal 804 after it is determined that the current environment has substantial electromagnetic interference. The compass is disposed at the movable platform for determining a movement direction of the movable platform.

In some embodiments, the change information includes at least one of a change frequency or a change amplitude of the output data of the compass.

In some embodiments, the controller 803 is configured to transmit the attitude angle of the movable platform to the gimbal 804 after it is detected that the current environment does not have substantial electromagnetic interference. The gimbal 804 is configured to control the frame structure of the gimbal 804 to rotate based on the attitude angle of the movable platform to follow the movable platform to rotate.

In some embodiments, specific implementation of the controller 803 of the movable platform can be referred to the description of the foregoing embodiments, and will not be repeated herein. In addition, FIG. 8 is for illustration purpose. Structural shapes of and positional relationship between function modules such as the propulsion assembly 802, the controller 803, the gimbal 804, and the load equipment 805 may be combined in various forms, which are not limited by the present disclosure. At the same time, relationship between various functional uses of the controller 803 and the gimbal 804 can be referred to the description of the relationship between relevant method steps in the foregoing embodiments.

In some embodiments, when the gimbal is controlled to follow the movable platform to rotate, no attitude data is provided by the movable platform. When the sensors disposed at the movable platform are interfered by the environment, especially the compass at the movable platform is interfered by substantial electromagnetic interference, desired gimbal control is ensured in various environment, and the load equipment such as the photographing device can follow the movable platform to rotate.

A person of ordinary skill in the art can understand that all or part of the processes in the foregoing method embodiments can be implemented by instructing relevant hardware through a computer program. The computer program can be stored in a computer-readable storage medium. When being executed, the computer program performs the processes of the foregoing method embodiments. The storage medium includes a magnetic disk, an optical disk, a read-only memory (ROM), or a random-access memory (RAM), etc.

In the specification, specific examples are used to explain the principles and implementations of the present disclosure. The description of the embodiments is intended to assist comprehension of the methods and core inventive ideas of the present disclosure. At the same time, those of ordinary skill in the art may change or modify the specific implementation and the scope of the application according to the embodiments of the present disclosure. Thus, the content of the specification should not be construed as limiting the present disclosure.

What is claimed is:

1. A method for controlling a gimbal comprising:
in response to a trigger signal, obtaining an attitude angle of the gimbal and an attitude angle of a base coupled to the gimbal; and
controlling the gimbal to rotate based on the attitude angle of the base and the attitude angle of the gimbal, such that the gimbal follows the base to rotate.

2. The method according to claim 1, wherein controlling the gimbal to rotate based on the attitude angle of the base and the attitude angle of the gimbal includes:
calculating follow information based on the attitude angle of the base and the attitude angle of the gimbal; and
controlling the gimbal to rotate based on the follow information.

3. The method according to claim 2, wherein calculating the follow information based on the attitude angle of the base and the attitude angle of the gimbal includes:
calculating an angle change value between the attitude angle of the base and the attitude angle of the gimbal; and
calculating the follow information based on the angle change value.

4. The method according to claim 3, wherein calculating the follow information based on the angle change value includes:
performing a correction process on the follow information to obtain corrected follow information.

5. The method according to claim 4, wherein performing the correction process on the follow information to obtain the corrected follow information includes:
performing a calculation on the angle change value and a rotation velocity threshold based on an error quadratic curve calculation rule using a pre-configured proportional coefficient to obtain the corrected follow information.

6. The method according to claim 5, wherein:
the rotation velocity threshold includes a maximum rotation velocity of the gimbal.

7. The method according to claim 2, wherein:
the follow information includes at least one of angle information, angular velocity information, or angular acceleration information.

8. The method according to claim 1, wherein:
the gimbal includes a motor assembly; and
obtaining the attitude angle of the base includes:
obtaining a joint angle of the motor assembly; and
calculating the attitude angle of the base according to the joint angle of the motor assembly and the attitude angle of the gimbal.

9. The method according to claim 1, wherein obtaining the attitude angle of the base includes:
obtaining the attitude angle of the base from a sensor provided at the base.

10. The method according to claim 1, wherein:
the gimbal includes a frame structure including at least one of a yaw-axis frame, a roll-axis frame, or a pitch-axis frame; and
controlling the gimbal to rotate based on the attitude angle of the base and the attitude angle of the gimbal includes performing at least one of:
controlling the gimbal to rotate in a yaw direction based on the attitude angle of the base, such that a yaw angle of the gimbal and a yaw angle component of the attitude angle of the base satisfy a first similarity condition;
controlling the gimbal to rotate in a pitch direction based on the attitude angle of the base, such that a pitch angle of the rotated gimbal and a pitch angle component of the attitude angle of the base satisfy a second similarity condition; or
controlling the gimbal to rotate in a roll direction based on the attitude angle of the base, such that a roll angle of the rotated gimbal and a roll angle component of the attitude angle of the base satisfy a third similarity condition.

11. The method according to claim 1, further comprising:
detecting whether the trigger signal is received before obtaining the attitude angle of the gimbal and the attitude angle of the base.

12. The method according to claim 11, wherein:
the trigger signal is transmitted by a movable platform to indicate that a current environment has substantial electromagnetic interference, the movable platform being coupled to the gimbal via the base.

13. The method according to claim 11, further comprising:
obtaining attitude data transmitted by the movable platform in response to not receiving the trigger signal; and
controlling the gimbal to rotate based on the attitude data transmitted by the movable platform, such that the gimbal follows the movable platform to rotate.

14. A control device comprising:
a communication interface configured to be connected to a gimbal connected to a base; and
a controller configured to:
in response to a trigger signal, obtain an attitude angle of the gimbal and an attitude angle of the base; and
control the gimbal to rotate based on the attitude angle of the base and the attitude angle of the gimbal, such that the gimbal follows the base to rotate.

15. The control device according to claim 14, wherein the controller is further configured to:
calculate follow information based on the attitude angle of the base and the attitude angle of the gimbal; and
control the gimbal to rotate based on the follow information.

16. The control device according to claim 15, wherein the controller is further configured to:
calculate an angle change value between the attitude angle of the base and the attitude angle of the gimbal; and
calculate the follow information based on the angle change value.

17. The control device according to claim 16, wherein the controller is further configured to:
perform a correction process on the follow information to obtain corrected follow information.

18. The method according to claim 17, wherein the controller is further configured to:
perform a calculation on the angle change value and a rotation velocity threshold based on an error quadratic curve calculation rule using a pre-configured proportional coefficient to obtain the corrected follow information.

19. The control device according to claim 18, wherein:
the rotation velocity threshold includes a maximum rotation velocity of the gimbal.

20. A movable platform comprising:
a body;
a propulsion assembly configured to provide propulsion for the movable platform;
a gimbal coupled to the body via a base; and
a controller configured to control the propulsion assembly and to:
in response to a trigger signal, obtain an attitude angle of the gimbal and an attitude angle of the base; and
control the gimbal to rotate based on the attitude angle of the base and the attitude angle of the gimbal, such that the gimbal follows the base to rotate.
